(19) United States
(12) Patent Application Publication
(10) Pub. No.: US 2024/0381080 A1
(43) Pub. Date: Nov. 14, 2024

(54) SYSTEMS AND METHODS FOR SECURE AUTHENTICATION INFORMATION RETRIEVAL

(71) Applicant: Capital One Services, LLC, McLean, VA (US)

(72) Inventors: Martin FIGUEROA-RAMIREZ, Silver Spring, MD (US); Jennifer KWOK, Brooklyn, NY (US); Susan Hogan DAVIS, Alexandria, VA (US); Tara Ann HICKEY, Herndon, VA (US)

(73) Assignee: Capital One Services, LLC, McLean, VA (US)

(21) Appl. No.: 18/315,465

(22) Filed: May 10, 2023

(51) Int. Cl. H04W 12/06

(52) U.S. Cl. CPC H04W 12/06

(57) ABSTRACT

Systems and methods for secure authentication information retrieval. In some aspects, the system receives a request for accessing authentication information for an authentication token. The system retrieves a user profile for the user comprising token identifiers for authentication tokens associated with the user and authentication information for each authentication token. The system receives an indication that a near field communication (NFC) interaction has been initiated between the user device and the authentication token. The system determines whether the authentication token is associated with the user and renders the authentication information into a graphical overlay. The system may additionally transmit the graphical overlay for displaying the authentication information over an image of the authentication token captured via an imaging sensor included in the user device.

### SUMMARY

Authentication tokens, such as identification authentication tokens or the like, provide a convenient mechanism for authenticating users to enable them to perform restricted actions or access privileged information. In many examples, such authentication tokens provide sensitive and personal information on the physical token itself, as well as wireless technology, such as microchips that enable secure authentication via wireless communications. For example, identification badges to access buildings often include names and photos of employees and identification cards include identification or serial numbers.

Having authentication information on the physical token can be undesirable for many reasons. Personal and sensitive information on a physical token itself can be dangerous as physical tokens are often lost or stolen by bad actors. This could leave token owners or entities vulnerable to unauthorized access to resources. Authentication information, such as authentication token number or expiry date of the physical tokens, which may be necessary for authentication, may be easily damaged and rendered unrecognizable.

Accordingly, among other things, a mechanism is desired that enables a user of the authentication token to securely retrieve and view authentication information of the authentication token, for example, without providing the authentication information on the physical token. For example, an authentication token may be provided that may connect to a user's device via wireless communications (e.g., near field communication (NFC)). Given that the user device has an active session (e.g., has logged in or provided credentials), the authentication information associated with the authentication token may be viewed via the user's device. For example, the authentication information may be displayed over an image of the authentication token captured via an imaging sensor included in the user device. In some examples, the authentication token may have no information provided thereon (e.g., viewable to others, on the surface of the token, etc.).

In some aspects, systems and methods for secure authentication information retrieval for authentication tokens using augmented reality are described. The method may include receiving, from a user device associated with a user, a request for accessing authentication information for an authentication token, wherein the request comprises a session identifier associated with the user device. The method may include retrieving, based on the session identifier, a user profile for the user, wherein the user profile comprises (1) token identifiers for one or more authentication tokens associated with the user, and (2) authentication information of each of the one or more authentication tokens. The method may include receiving an indication that an NFC interaction has been initiated between the user device and the authentication token, wherein the indication includes a token identifier for the authentication token.

The method may include determining whether the authentication token is associated with the user. The method may include, in response to determining that the authentication token is associated with the user, rendering the authentication information into a graphical overlay for display on the user device. The method may include transmitting to the user device the graphical overlay for displaying, on a display of the user device, the authentication information over an image of the authentication token captured via an imaging sensor included in the user device.

In some examples, the session may be expired, and the user may be required to input user credentials once again. The system may determine whether session data associated with the session identifier is present in a session store and, in response to determining that the session data is not present in the session store, transmit, to the user device, a command for displaying a request for access information on a display of the user device.

In some examples, determining that the authentication token is associated with the user comprises comparing the token identifier for the authentication token and the token identifiers from the user profile and determining that the token identifier for the authentication token corresponds to one of the token identifiers from the user profile.

In some examples, the method may include determining, based on the user profile, one or more user actions associated with the authentication token, rendering one or more options for performing the one or more user actions into a second graphical overlay for display on the user device, and transmitting to the user device the second graphical overlay for displaying, on a display of the user device, the one or more options for performing the one or more user actions.

In some examples, the method may include, in response to receiving a second indication of a user selection for performing a user action of the one or more user actions, transmitting a command for performing the user action.

In some examples, display of the authentication information may be obfuscated or terminated to prevent unwanted disclosure of a user's authentication information (e.g., if the user is no longer within proximity of the user device, if some time has passed, etc.). For example, the method may include receiving a second indication that the user is not within proximity of the user device as determined by a second imaging sensor included in the user device, and transmitting, to the user device, a command to terminate display of the graphical overlay of the authentication information. In another example, the method may include determining whether a threshold period of time has been exceeded since transmitting the graphical overlay for display, in response to determining that the threshold period of time has been exceeded, rendering the authentication information into an obfuscated graphical overlay for display on the user device, and transmitting to the user device the obfuscated graphical overlay for displaying on a display of the user device.

Alternatively, or additionally, the method may include, in response to an indication that the NFC interaction has ended, transmitting to the user device a command to terminate display of the graphical overlay of the authentication information.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 illustrates an overview of an example implementation, in accordance with one or more embodiments described herein.

FIG. 2 is a block diagram of a card data visualization system, in accordance with one or more embodiments described herein.

FIG. 3 is a block diagram of an example presentation component, in accordance with one or more embodiments described herein.

FIG. 4 is a flow chart diagram of a method of authentication information retrieval, in accordance with one or more embodiments described herein.

FIG. 5 is a flow chart diagram of a method of determining and presenting a discount associated with an authentication token, in accordance with one or more embodiments described herein.

FIG. 6 is a flow chart diagram of a method of authentication token data security, in accordance with one or more embodiments described herein.

FIG. 7 is a flow chart diagram of a method of card data visualization in a virtual environment, in accordance with one or more embodiments described herein.

FIG. 8 is a block diagram illustrating a suitable operating environment for aspects of the subject disclosure, in accordance with one or more embodiments described herein.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Authentication tokens, such as physical payment cards (e.g., credit cards) or identification cards provide a convenient mechanism for authenticating users to enable them to perform transactions, restrict actions, and/or access privileged information. Authentication tokens often provide sensitive and personal information on the physical token itself, as well as wireless technology, such as microchips that enable secure authentication via wireless communications. For example, a physical authentication token may be a payment card, such as a credit card, that facilitates electronic payment for goods or services. A payment card can be presented at a point-of-sale terminal, which acquires payment card details. Subsequently, the details are sent to the merchant or acquiring bank or processor through a network. The acquiring bank or processor forwards the details to a payment card network, which requests payment authorization from an issuing bank of the payment card. If funds are available, the issuing bank can send an approval code through the payment card and acquiring bank networks to the merchant. Subsequently, the merchant can send the approval code through the networks, which results in a debit from an issuing bank account and a credit to a merchant or acquiring bank account.

Traditional payment cards include data required to make an electronic payment, as well as additional optional information. In particular, a payment card (e.g., a credit card) can include a unique sixteen-digit card number, cardholder name, and expiration date. This data can be printed or embossed on the front of the payment card in addition to the card issuer's name. Further, the data can include a security code printed on the back of the card and a magnetic strip that encodes such data.

Having authentication information on the physical token, such as the cardholder name, card number, and expiration date can be undesirable for many reasons. Physical cards are often lost or stolen, and anyone who is in custody of the physical card may use the card number and expiration date to make purchases using the cardholder's resources and assets. Furthermore, authentication information, such as alphanumeric data printed or embossed on a physical authentication token, is a security risk. Visible data is susceptible to overlooking eyes and cameras and can be utilized to perpetrate fraud. For example, payment data is printed or embossed on many physical cards and often includes the cardholder's first and last name, a sixteen-digit account number, an expiration date, and a security code. Exposure of such payment data poses a fraud risk. However, payment data is needed for transactions outside a payment terminal, such as internet-based purchases.

Furthermore, physical authentication tokens often include information regarding payment network (e.g., Visa, MasterCard) an authentication token issuer (e.g., bank), as well as computer chips, antennas, and a magnetic strip. This information and electronic structure are static and unchanging. Further, given that payment authentication tokens are limited in size, typically about three inches by two inches, available authentication token real estate for additional data is constrained.

Accordingly, among other things, a mechanism is desired that enables secure retrieval of authentication information of the authentication token by a user of the authentication token, for example, without providing the authentication information on the physical token. For example, an authentication token may be provided that may connect to a user's device via wireless communications (e.g., NFC). Given that the user device has an active session (e.g., has logged in or provided credentials), the authentication information associated with the authentication token may be viewed via the user's device. For example, the authentication information may be displayed over an image of the authentication token. In some examples, the authentication token may have no information provided thereon (e.g., viewable to others, on the surface of the token, etc.).

For example, a physical card can be detected as present or within a predetermined distance utilizing computer vision technology or wireless communication, among other things. A unique identifier associated with a detected card can be read or otherwise acquired. Card data can be acquired from a computer-readable storage medium based on the unique identifier. A visualization can be generated from at least a subset of the card data and transmitted to a device for display. In one instance, the visualization can target augmented reality and an augmented reality device and display, such that the data is projected on or around the card. In another instance, the visualization can be tailored to virtual reality. Various security mechanisms can be employed to mitigate risk when data is presented. Furthermore, additional data related to a card can be acquired and visualized.

Disclosed embodiments pertain to authentication information retrieval. A physical payment authentication token need not print much, if any, payment data on the authentication token. The payment authentication token can include a unique identifier that ties the payment authentication token to an individual and the individual's account. Based on an electronic or printed unique identifier, payment data can be looked up locally or remotely and projected onto the payment authentication token, for example, on an augmented reality display. Further, the projection can be performed as needed, limiting the time payment data is exposed. Additional security mechanisms can also be employed when the payment data is exposed to mitigate the likelihood of viewing or capturing the payment data when it is presented. Furthermore, authentication token space is not limited by an authentication token's physical dimensions. As such, the payment data or additional data can be projected around or near the authentication token. Furthermore, an electronic payment authentication token with the payment data can be generated and presented to a user in virtual reality.

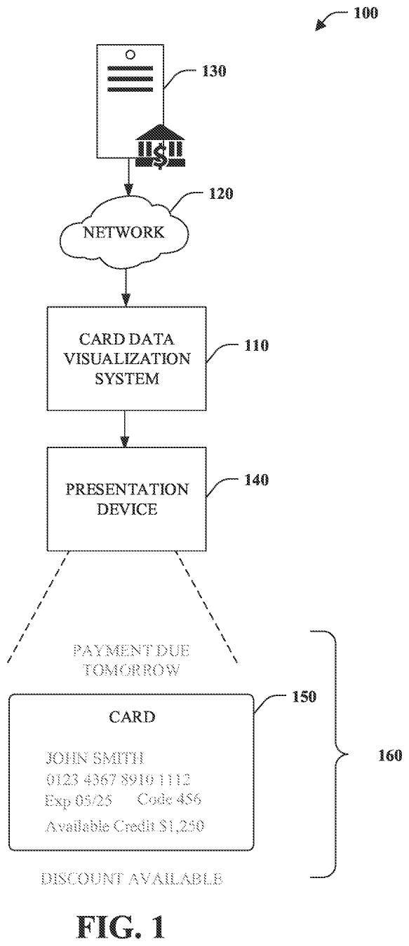

Referring initially to FIG. 1, a high-level overview of an example implementation 100 is depicted. The implementation 100 includes card data visualization system 110, network 120, data service 130, card 150, and visualization 160.

As referred to herein, an authentication token may be a physical and/or virtual token with associated information that authenticates or authorizes a user to allow a user to perform restricted actions, access privileged information, and/or the like. In examples herein, an authentication token may be a physical card, such as a credit card, debit card, employee identification, etc. The authentication token may have the associated authentication information provided thereon or, as described herein, the authentication information may be provided to the user via a display.

The card data visualization system 110 is configured to interact with the data service 130 over the network 120. The data service 130 can include information associated with an authentication token (e.g., card) holder, such as, but not limited to, first name, last name, and account number. The network 120 can correspond to a wide area network, such as the internet or the world wide web. The card data visualization system 110 can acquire data from the data service 130 and store the data locally for subsequent expeditious retrieval. Further, the data can be acquired and saved locally and optionally uploaded to the data service 130.

The presentation device 140 can correspond to any device with a display. For instance, the presentation device 140 can be a smartphone, augmented reality glasses, or a virtual reality headset. The presentation device 140 can receive a visualization 160 of data for presentation from the card data visualization system 110. The visualization 160 can then be displayed on or near the card 150.

The authentication token can correspond to a physical authentication token, such as a credit authentication token, debit authentication token, business authentication token, rewards authentication token, license, or library authentication token, among other things. In one instance, the physical authentication token can include a visible or electronic unique identifier associated with a particular individual. For example, the authentication token can include a unique name, number, or code, such as a bar code, that is linked to an individual or individual's account. The unique identifier can be received, retrieved, or otherwise obtained or acquired from the card 150 and used by the card data visualization system 110 to locate and acquire authentication token data locally or remotely.

In one instance, the card 150 can correspond to a credit authentication token. A unique identifier associated with the authentication token can be read from the authentication token utilizing a computer vision technique, such as optical character recognition or bar code recognition. Alternatively, the unique identifier can be received, retrieved, or otherwise acquired electronically, for example, by way of wireless communication. For instance, the presentation device can be a smartphone that can use a camera to capture and recognize a printed identifier or communicate using short-range radio frequency with the authentication token to acquire the identifier. Once the unique identifier is obtained, the identifier can be utilized to look up data associated with an individual or an individual's account. The lookup or search can be performed locally or remotely over the network 120 to the data service 130. For example, a user's name, account number, expiration date, and security code associated with the card 150 can be located. The visualization 160 can be generated that includes such data, and the visualization 160 can be projected or otherwise presented with respect to the authentication token by the presentation device 140. For example, a smartphone or glasses can present the visualization 160 in augmented reality. Further, information can be acquired regarding an account, including an upcoming payment due date and available discount or reward. This information can be incorporated into the visualization 160 or a different visualization and presented on or near the card 150.

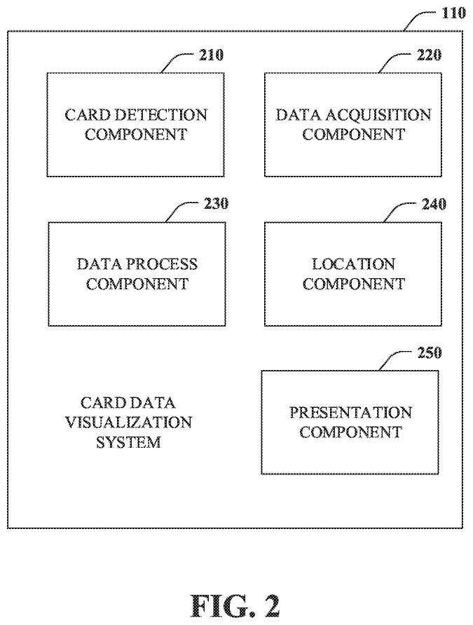

Turning attention to FIG. 2, a card data visualization system 110 is illustrated in further example detail. The card data visualization system 110 includes card detection component 210, data acquisition component 220, data process component 230, location component 240, and presentation component 250. The card detection component 210, data acquisition component 220, data process component 230, location component 240, and presentation component 250 can be implemented by at least one processor coupled to a memory that stores instructions that cause the processor to perform the functionality of each component when executed. Consequently, a computing device can be configured to be a special-purpose device or appliance that implements the functionality of the card data visualization system 110. Further, all or portions of the card data visualization system 110 can be distributed across computing devices or made accessible by way of a network service.

The card detection component 210 is operable to detect the presence of a physical authentication token. The presence can be within a predetermined distance from a computing device such as a smartphone. In accordance with one aspect, the card detection component 210 can analyze an image or series of images and employ machine learning and object detection to detect a physical authentication token. More specifically, the card detection component 210 can be configured to identify the size and shape of a physical authentication token, as well as other markings that distinguish a physical authentication token from other physical authentication tokens. For example, an image can be captured by a smartphone or smart glasses and analyzed to determine if a physical authentication token is present based on at least the size and shape, as well as whether it is a particular type of authentication token associated with further processing. In accordance with another aspect, the card detection component 210 can employ a wireless signal to detect the presence of a physical authentication token. A physical authentication token, such as an access control authentication token, business authentication token, or payment authentication token, can include contactless features supported by a microchip, antenna, and radio frequency transmission. For instance, short-range radio frequency or other wireless communication means can be employed to announce the presence of the authentication token either proactively or in response to a request. The card detection component 210 can receive, retrieve, or otherwise detect the wireless signal to determine the presence of a physical authentication token.

Regardless of implementation, the card detection component 210 can also be configured to determine or detect a unique identifier (e.g., name, code, account number, image) associated with the authentication token. For example, the authentication token detection component can detect alphanumeric characters or a code, such as a barcode, printed or embossed on an authentication token, for instance, using optical character recognition or barcode recognition functionality. Alternatively, the card detection component 210 can receive or retrieve a unique identifier wirelessly from the authentication token.

The data acquisition component 220 is configured to locate and acquire data associated with a particular individual or account. As noted above, the card detection component 210 can identify a unique identifier associated with a physical authentication token. The unique identifier can be utilized as a key to look up and acquire data. The data acquisition component 220 can search a local store or repository for data. If the data is not saved locally, the data acquisition component 220 can query an online store or request the data from a network service based on the unique identifier. The data can include, among other things, a user's name, account number, expiration date, and security code.

The data process component 230 is configured to process data acquired by the data acquisition component 220, among other sources. The data process component 230 can process data to produce additional data, enable further processing, and trigger actions. For example, data can include the due date for payment on an account. The data process component 230 can compute the number of days remaining until the due date, compare the number of days to a predetermined threshold, and trigger generation and presentation of a warning or notification when the number of days satisfies the predetermined threshold.

The location component 240 is configured to determine the geographic location of a physical authentication token. In one instance, the location can be determined based on wireless connections to known locations. Additionally, or alternatively, the location component 240 can utilize a global positioning system associated with an authentication token or computing device. For example, the card detection component 210 can detect an authentication token in proximity to a computing device, such as a smartphone. Global positioning or other systems can be utilized on the computing device to determine the location of the computing device, which can then be assigned to the physical authentication token.

In accordance with one embodiment, the geographic location identified by the location component 240 can be used as a key to search for and locate a discount or the like. In some situations, authentication token accounts include benefits such as discounts at certain places of business, access to special events, or the like. Further, such benefits can be location-based. Accordingly, the data process component 230, in conjunction with the data acquisition component 220, can use the location and search for applicable benefits within a predetermined distance of the location. For example, a number of retail stores can be identified within a predetermined distance if the location can be determined. Next, a search can be made as to whether there are any benefits associated with the number of retail stores. For example, a user's benefit can provide ten percent off purchases at a particular store, and this benefit can be identified as subsequently presented in conjunction with the authentication token.

The presentation component 250 is configured to present authentication token data on or near a physical authentication token as needed. Consequently, exposure of authentication token data can be limited in time. Further, the presentation component 250 can generate a visualization for presentation that is particular to a display device. Given the diminutive nature of a physical authentication token, as well as display devices such as smartphones and augmented reality glasses, the visualization is generated in a manner that is clear and organized to facilitate understanding. Furthermore, the presentation component 250 can employ one or more security mechanisms to reduce the risk that presented authentication token data can be captured and utilized to perpetrate fraud.

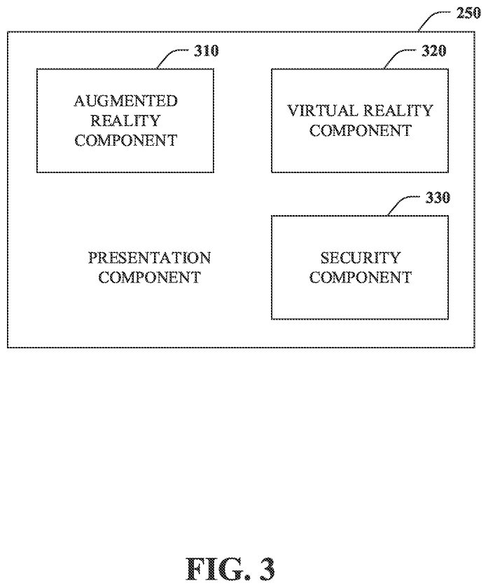

FIG. 3 depicts the presentation component 250 in further example detail. As shown, the presentation component 250 includes augmented reality component 310, virtual reality component 320, and security component 330. These components or sub-components can be implemented by at least one processor coupled to a memory that stores instructions that cause the processor to perform the functionality of each component or subcomponent when executed. Consequently, a computing device can be configured as a special-purpose device or appliance that implements the functionality of the presentation component 250.

The augmented reality component 310 is configured to generate visualizations designed to exploit augmented reality. For example, when an authentication token is in view, the authentication token's size, shape, and angle can be considered when generating a visualization. More specifically, content designed to be presented on the authentication token, such as authentication token number and expiration date, can cause the augmented reality component 310 to generate a visualization that displays such data on the authentication token. Further, since augmented reality can expand the real estate associated with an authentication token, the augmented reality component 310 can produce a visualization that positions some data off the authentication token but nearby, such as above the authentication token, below the authentication token, or to the side of the authentication token.

The virtual reality component 320 generates a visualization for virtual reality instead of augmented reality. In accordance with one aspect, the virtual reality component 320 can generate a visual representation of an authentication token with corresponding data. Further, data need not be confined to the authentication token but also can be presented around or near the authentication token. Accordingly, the virtual reality component 320 can support generation of a visualization on or near a virtual reality authentication token.

The security component 330 is configured to provide features to further secure data when exposed. One feature can limit the time the data is visible. Another feature can detect the presence of faces or cameras in view and modify operation to mitigate visibility. For example, the security component 330 can employ face detection to detect a user's face and present data when detected. However, if the user's face is not detected or an additional face, different face, or recording device is detected, a warning can be presented, or the data display can be obscured or terminated.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Furthermore, one or more components and/or sub-components can be combined into a single component to provide aggregate functionality. Communication between systems, components, or sub-components can be accomplished following either a push or pull control model. The components can also interact with one or more other components not specifically described herein for the sake of brevity but known by those of skill in the art.

Various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, and classifiers). Such components, among others, can automate certain mechanisms or processes, thereby making portions of the systems and methods more adaptive, as well as efficient and intelligent. By way of example, and not limitation, the card data visualization system 110 and components thereof can employ such mechanisms to read text or codes, detect the presence of an authentication token and positioning, perform facial recognition in conjunction with security features, and predict offers or discounts of interest to a user, among other things.

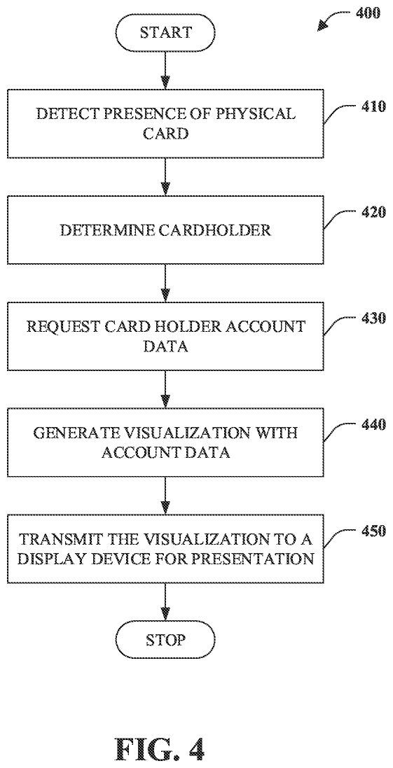

In view of the example systems described above, methods that can be implemented in accordance with the disclosed subject matter will be better appreciated with reference to the flow chart diagrams of FIGS. 4-7. While, for purposes of simplicity of explanation, the methods show and describe a series of blocks, it is to be understood and appreciated that the disclosed subject matter is not limited by the order of the blocks, as some blocks can occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

Turning attention to FIG. 4, a flow chart diagram depicts a method 400 of authentication information retrieval. The method 400 can be implemented and performed by card data visualization system 110 and components thereof.

At reference numeral 410, the method 400 can detect the presence of a physical authentication token. A physical authentication token can correspond to a business, reward, gift, debit, or credit authentication token, among others. The presence can be detected utilizing computer vision technology, including object detection. Additionally, or alternatively, the physical authentication token can be detected based on unique characters or a code on the physical authentication token that can be read automatically utilizing optical character or bar code recognition technology. Further, a wireless signal can be detected from the authentication token indicating the presence or a user can signal the presence of an authentication token, for instance, by activating a button on a computing device.

According to some examples, a system may receive an indication that an NFC interaction (and/or other wireless interaction) has been initiated between the user device and the authentication token (e.g., card), wherein the indication includes a token identifier for the authentication token.

At numeral 420, the method 400 can determine a user or account associated with the user. In one instance, optical character recognition can be employed to read and recognize a unique identifier printed or embossed on the physical authentication token. The unique identifier can be a user name, account number, or any other unique series of alphanumeric characters. Alternatively, the unique identifier can be encoded in a barcode, which can be read with barcode reader technology. Additionally, or alternatively, the unique identifier can be communicated through a wireless signal.

According to some examples, a system may determine the user or user account based on a session identifier included in a request to the system. For example, when a user opens an application (e.g., an application hosted by the authentication token issuer) for the first time, the user may be required to log in using user credentials (e.g., username, password). The system may generate a unique session identifier to associate the user device and session and to maintain a session state. In subsequent instances when the user opens the application, the user may request to access the information in the system by transmitting the session identifier. For example, the method may include receiving, from a user device associated with a user, a request for accessing authentication information for an authentication token, wherein the request comprises a session identifier associated with the user device.

The system may determine the user based on the session identifier transmitted. For example, the system may compare the token identifier for the authentication token and the token identifiers from the user profile and determine that the token identifier for the authentication token corresponds to one of the token identifiers from the user profile.

In some examples, the session may be expired, and the user may be required to input user credentials once again. The system may determine whether session data associated with the session identifier is present in a session store and, in response to determining that the session data is not present in the session store, transmit, to the user device, a command for displaying a request for access information on a display of the user device.

At reference numeral 430, the method 400 can request user account data. User data can include name, address, account number, expiration date, or security code, among other things. The unique identifier can be utilized as a key to look up user account data. In one scenario, the account data can be received, retrieved, or otherwise obtained or acquired from a remote network service. For example, a bank associated with an account can be queried for user account data. Alternatively, the user account data can be requested and received from a local store.

For example, according to some embodiments, the system may retrieve, based on the session identifier, a user profile for the user, wherein the user profile comprises (1) token identifiers for one or more authentication tokens associated with the user, and (2) authentication information of each of the one or more authentication tokens. The system may determine whether the authentication token is associated with the user. The system may determine that the authentication token is associated with the user, for example by comparing the token identifier for the authentication token and the token identifiers from the user profile and determining that the token identifier for the authentication token corresponds to one of the token identifiers from the user profile.

At reference numeral 440, the method 400 generates a visualization which includes the account data. The visualization can specify the size, color, font, and other text characteristics. The visualization can also specify the spacing between text fields. Further, the visualization can optionally include an image, graphic, animation, or video. For example, the visualization can include a logo of a bank or credit authentication token processor. In one instance, the visualization can be tailored to a particular display device or environment. For example, in response to determining that the authentication token is associated with the user, the system may render the authentication information into a graphical overlay for display on the user device.

At 450, the method 400 can transmit the visualization to a display device for presentation. The display device can be a smart phone, glasses, or watch, among other things. In one instance, devices can operate in combination with other devices. For example, a smartphone can perform processing to generate a visualization and convey the visualization wirelessly to smart glasses or a smart watch for display.

For example, the system may transmit to the user device the graphical overlay for displaying, on a display of the user device, the authentication information over an image of the authentication token captured via an imaging sensor included in the user device.

In some examples, display of the authentication information may be obfuscated or terminated to prevent unwanted disclosure of a user's authentication information (e.g., if the user is no longer within proximity of the user device, if some time has passed, etc.). For example, the method may include receiving a second indication that the user is not within proximity of the user device as determined by a second imaging sensor included in the user device, and transmitting, to the user device, a command to terminate display of the graphical overlay of the authentication information.

In other examples, the method may include determining whether a threshold period of time has been exceeded since transmitting the graphical overlay for display. In response to determining that the threshold period of time has been exceeded, the system may render the authentication information into an obfuscated graphical overlay for display on the user device and transmit to the user device the obfuscated graphical overlay for displaying on a display of the user device. Alternatively, or additionally, the system may, in response to an indication that the NFC interaction has ended, transmit to the user device a command to terminate display of the graphical overlay of the authentication information.

According to some examples, the method may further include determining, based on the user profile, one or more user actions associated with the authentication token. One or more options for performing the one or more user actions may be rendered into a second graphical overlay for display on the user device and transmitted to the user device the second graphical overlay for displaying, on a display of the user device, the one or more options for performing the one or more user actions. In response to receiving a second indication of a user selection for performing a user action of the one or more user actions, a command may be transmitted for performing the user action.

As described herein, a user action may be, for example, a user action to see more information associated with the user, and/or an authentication token. In the example where the authentication token is a payment card (e.g., credit card, debit card, etc.), the user actions may include actions to pay a remaining balance, a current balance, etc., on the authentication token, to freeze or unfreeze the token (e.g., prevent the token from being used), to see more information regarding transactions for the card, to perform actions based on one or more rewards (e.g., acquiring cash back or accruing travel credits due to usage of the authentication token).

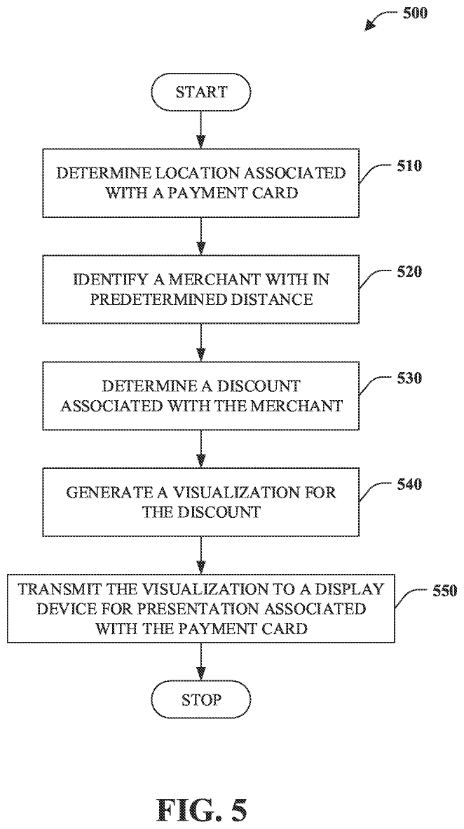

FIG. 5 is a flow chart diagram of a method 500 of determining and presenting a discount associated with a payment authentication token. The method 500 can be implemented by the card data visualization system 110 and components thereof, including the location component 240 and the data process component 230.

At reference numeral 510, the method 500 determines a location associated with a physical authentication token, such as a payment authentication token. Various technologies and mechanisms can be employed to determine the geographic location of the payment authentication token. For example, the payment authentication token can be linked to a computing device, such as a smartphone, that can employ a global positioning system or triangulation of wireless signals, including a cell phone signal or wireless network protocol (e.g., Wi-Fi, Bluetooth) to determine location. Additionally, or alternatively, the payment authentication token itself can include global positioning system components or the like to determine location. Further, an authentication token reader can record the location of the authentication token reader and make the location available to a computing device, such as a smartphone or tablet.

At numeral 520, the method seeks to identify a merchant within a predetermined distance of the location of the payment authentication token. The predetermined distance can be in miles, yards, or feet to limit merchants to particular distance degrees, including far, close, or in a merchant store. Based on the current geographic location and the predetermined distance, a set of one or more merchants within the area is determined.

At reference 530, the method 500 determines a discount associated with an identified merchant. An authentication token issuer (e.g., company, bank, store, authentication token servicer) can often negotiate discounts with merchants on behalf of their users. A database of merchants and applicable discounts can be searched for the identified merchant. If a discount is available, information regarding the discount is saved.

At numeral 540, the method 500 generates a visualization for an identified discount. The visualization can include text, graphics, images, or videos identifying the merchant and discount. The visualization can include text describing the discount and any terms or conditions surrounding the discount. Alternatively, the visualization can correspond to a coupon or the like that describes the discount. Further, the visualization can be specific to a presentation type. For example, a visualization for an augmented reality display can differ from other displays, at least in that visualizations are not confined to the physical size of an authentication token.

At reference numeral 550, the method 500 transmits the visualization to a display device for presentation associated with the payment authentication token. The visualization can be displayed in augmented reality on or near the payment authentication token. For example, the visualization can be presented below the authentication token in augmented reality. The visualization can be a single visualization associated with the discount or a combined visualization that includes payment authentication token data and discount information.

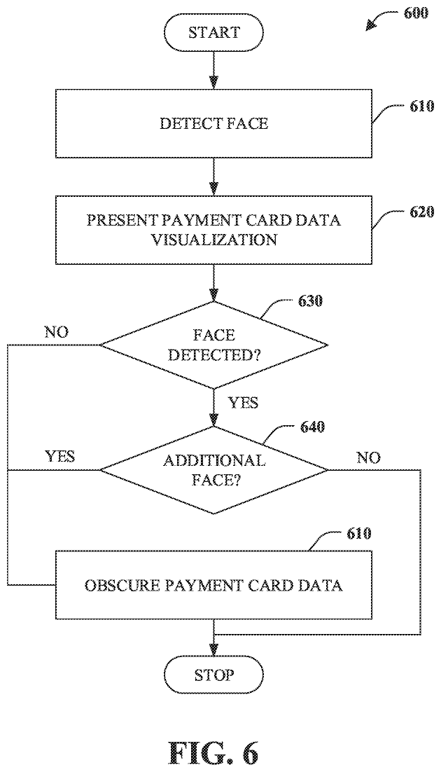

FIG. 6 is a flow chart diagram of a method 600 of authentication token data security in accordance with one aspect. The method 600 can be implemented by the card data visualization system 110 and components thereof, including the presentation component 250 and security component 330.

At reference numeral 610, the method 600 detects a face. Computer technology can be employed to identify a face in a digital image or video. Face detection algorithms can seck to match human faces to identified images stored in a database. In one instance, machine learning can be employed to learn and detect faces. The method 600 can detect the presence of a face versus no face. However, the method 600 can be configured to detect the presence of a face associated with a user or particular user.

At numeral 620, a visualization of the authentication token data can be presented. For example, the visualization, including authentication token data and potentially other information, can be projected on or around a physical authentication token. For example, payment information, such as an account number, user name, expiration date, and security code, can be projected on an authentication token missing such information.

At reference 630, the method 600 determines whether a face is still detected. In one embodiment, the face can be any human face. In another embodiment, the determination can be whether the same face that was previously detected is still detected. If a face is detected (“YES”), the method 600 continues at 640. Alternatively, if the face is not detected (“NO”), the method 600 proceeds to 650.

At numeral 640, the method 600 determines whether or not an additional face is detected. In other words, the determination concerns whether two or more faces are detected, such that one of the two faces could be a fraudster seeking to capture authentication token data. If there is no additional face (“NO”), the method 600 simply terminates. If there is an additional face (“YES”), the method 600 continues at reference numeral 650.

At reference numeral 650, the method 600 obscures authentication token data and subsequently terminates. In one instance, the method 600 can obscure data by simply halting display. Alternatively, the display can be altered to make it difficult to view, for instance, by changing color, font, size, or brightness, among other things. Alone or as part of obscuring the authentication token data, the method 600 can display a warning that another individual is in the field of view. The warning can prompt a user to change locations or the position of a display device to improve privacy. In one scenario, face recognition technology can be employed to identify an individual based on a detected face and display the identity alone or in combination with the warning.

In an additional or alternate embodiment, the method 600 can be adapted to utilize machine learning object detection to detect a camera in the background. Detection of the camera can cause the method to obscure authentication token data similarly to avoid capture by the camera.

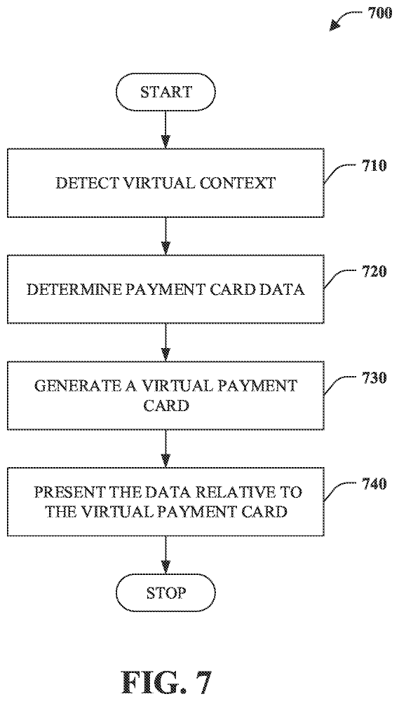

FIG. 7 is a flow chart diagram of a method 700 of card data visualization in a virtual environment. The card data visualization system 110, including components such as the virtual reality component 320, can implement the method 700 in one embodiment.

At reference numeral 710, the method 700 detects a virtual context. For example, the method 700 can detect a user's interaction with a virtual world or metaverse. Detection can be based on the activation of a particular software application or based on monitoring of a display. In one instance, presence at a particular location or event (e.g., concert, bank) can unlock a virtual world that provides a different experience. Further, the virtual context can involve providing payment information for a purchase.

At numeral 720, the method 700 determines payment authentication token data. In one instance, the payment authentication token data can be stored on a device and retrieved. Alternatively, a unique identifier associated with a physical authentication token can be identified and utilized to acquire the payment authentication token data from a network-accessible database. For example, a smartphone can receive, retrieve, or otherwise obtain or acquire a unique identifier from a physical authentication token through electronic communication or as a result of optical character recognition. The smartphone can next request payment authentication token data from a financial institution network service and receive the data in response to the request.

At reference numeral 730, the method 700 generates a virtual payment authentication token. The virtual payment authentication token can be a visualization of a payment authentication token, including a user's name, authentication token number, expiration date, and security code. In other words, the virtual payment authentication token can be a representation of a physical payment authentication token in a virtual world.

At numeral 740, the method 700 presents the virtual payment authentication token to a user within a virtual environment and context. For instance, a visualization of the virtual payment authentication token can be displayed in virtual reality. In this manner, the physical authentication token can transcend the physical world and be employable in virtual reality. For example, a virtual payment authentication token or a subset of payment data can be stored in a virtual wallet for purchases. Further, security mechanisms can be employed in the virtual world to prevent fraudsters from viewing or capturing payment data.

This disclosure pertains to the technical problem of physical authentication token data insecurity. Traditional printing or embossing data on a physical authentication token exposes the data that fraudsters can capture, for example, utilizing a camera or the like. The technical solution is to detect the presence of a physical authentication token with little or no data, identify a unique identifier associated with the physical authentication token, locate authentication token data on a computer-readable storage medium based on the unique identifier, and cause the authentication token data to be presented on or near the authentication token, for instance, in augmented reality. Given the diminutive nature of a physical authentication token, as well as display devices, such as smartphones or smart glasses, visualizations are generated to compensate and provide clear and organized data for case of use. Additional security mechanisms are also provided to mitigate the risk of a fraudster capturing authentication token data when presented.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component can be, but is not limited to, being a process running on a processor, a processor, an object, an instance, an executable, a thread of execution, a program, and/or a computer. By way of illustration, both an application running on a computer and the computer can be a component. One or more components can reside within a process and/or thread of execution, and a component can be localized on one computer and/or distributed between two or more computers.

As used herein, the term “infer” or “inference” generally refers to the process of reasoning about or inferring states of a system, a component, an environment, or a user from one or more observations captured by way of events or data, among other things. Inference can be employed to identify a context or an action or to generate a probability distribution over states, for example. An inference can be probabilistic. For example, computation of a probability distribution over states of interest can be based on a consideration of data or events. Inference can also refer to techniques employed for composing higher-level events from a set of events or data. Such inference can result in the construction of new events or new actions from a set of observed events or stored event data, whether or not the events are correlated in close temporal proximity, and whether the events and data come from one or several events and data sources.

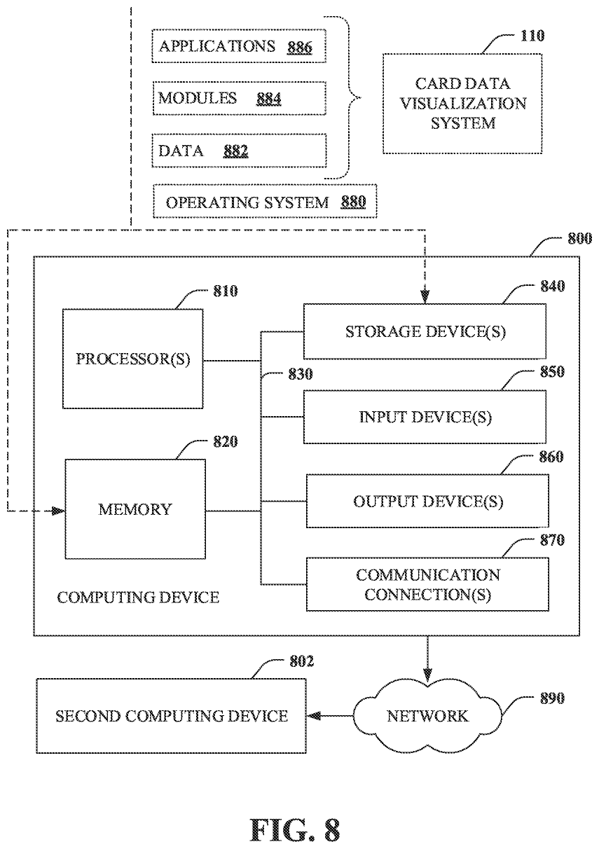

To provide a context for the disclosed subject matter, FIG. 8, as well as the following discussion, are intended to provide a brief, general description of a suitable environment in which various aspects of the disclosed subject matter can be implemented. However, the suitable environment is solely an example and is not intended to suggest any limitation on the scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, and data structures, among other things, which perform particular tasks and/or implement particular abstract data types. Moreover, those skilled in the art will appreciate that the above systems and methods can be practiced with various computer system configurations, including single-processor, multi-processor, or multi-core processor computer systems, mini-computing devices, server computers, as well as personal computers, hand-held computing devices (e.g., personal digital assistant (PDA), smartphone, tablet, watch, etc.), microprocessor-based or programmable consumer or industrial electronics, and the like. Aspects can also be practiced in distributed computing environments where tasks are performed by remote processing devices linked through a communications network. However, some, if not all, aspects of the disclosed subject matter can be practiced on standalone computers. In a distributed computing environment, program modules can be located in one or both of local and remote memory devices.

With reference to FIG. 8, illustrated is an example computing device 800 (e.g., desktop, laptop, tablet, watch, server, hand-held, programmable consumer or industrial electronics, set-top box, game system, compute node). The computing device 800 includes processor(s) 810, memory 820, system bus 830, storage device(s) 840, input device(s) 850, output device(s) 860, and communications connection(s) 870. The system bus 830 communicatively couples at least the above system constituents. However, the computing device 800, in its simplest form, can include one or more processor(s) 810 coupled to memory 820, wherein the one or more processor(s) 810 execute various computer-executable actions, instructions, and or components stored in the memory 820.

The processor(s) 810 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof, designed to perform the functions described herein. A general-purpose processor can be a microprocessor, but in the alternative, the processor can be any processor, controller, microcontroller, or state machine. The processor(s) 810 can also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 810 can be a graphics processor unit (GPU) that performs calculations concerning digital image processing and computer graphics.

The computing device 800 can include or otherwise interact with a variety of computer-readable media to facilitate control of the computing device to implement one or more aspects of the disclosed subject matter. The computer-readable media can be any available media accessible to the computing device 800 and includes volatile and nonvolatile media, and removable and non-removable media. Computer-readable media can comprise two distinct and mutually exclusive types: storage media and communication media.

Storage media includes volatile and nonvolatile, removable and non-removable media implemented in any method or technology to store information such as computer-readable instructions, data structures, program modules, or other data. Storage media includes storage devices such as memory devices (e.g., random access memory (RAM), read-only memory (ROM), electrically erasable programmable read-only memory (EEPROM)), magnetic storage devices (e.g., hard disk, floppy disk, cassettes, tape), optical disks (e.g., compact disk (CD), digital versatile disk (DVD), etc.), and solid-state devices (e.g., solid-state drive (SSD), flash memory drive (e.g., authentication token, stick, key drive), etc.), or any other like media that store, as opposed to transmit or communicate, the desired information accessible by the computing device 800. Accordingly, storage media excludes modulated data signals, as well as that which is described with respect to communication media.

Communication media embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media.

The memory 820 and storage device(s) 840 are examples of computer-readable storage media. Depending on the configuration and type of computing device, the memory 820 can be volatile (e.g., RAM), nonvolatile (e.g., ROM, flash memory, etc.), or some combination of the two. By way of example, the basic input/output system (BIOS), including basic routines to transfer information between elements within the computing device 800, such as during start-up, can be stored in nonvolatile memory, while volatile memory can act as external cache memory to facilitate processing by the processor(s) 810, among other things.

The storage device(s) 840 include removable/non-removable, volatile/nonvolatile storage media for storing vast amounts of data relative to the memory 820. For example, storage device(s) 840 include, but are not limited to, one or more devices, such as a magnetic or optical disk drive, floppy disk drive, flash memory, solid-state drive, or memory stick.

Memory 820 and storage device(s) 840 can include, or have stored therein, operating system 880, one or more applications 886, one or more program modules 884, and data 882. The operating system 880 acts to control and allocate resources of the computing device 800. One or more applications 886 include one or both of system and application software and can exploit management of resources by the operating system 880 through one or more program modules 884 and data 882 stored in the memory 820 and/or storage device(s) 840 to perform one or more actions. Accordingly, one or more applications 886 can turn a general-purpose computer, for example, computing device 800, into a specialized machine according to the logic provided.

All or portions of the disclosed subject matter can be implemented using standard programming and/or engineering techniques to produce software, firmware, hardware, or any combination thereof to control the computing device 800 to realize the disclosed functionality. By way of example and not limitation, all or portions of the card data visualization system can be, or form part of, the one or more applications 886, and include one or more program modules 884 and data 882 stored in memory and/or storage device(s) 840 whose functionality can be realized when executed by one or more processor(s) 810.

In accordance with one particular embodiment, the processor(s) 810 can correspond to a system on a chip (SOC) or like architecture including, or in other words integrating, both hardware and software on a single integrated circuit substrate. Here, the processor(s) 810 can include one or more processors, as well as memory at least similar to the processor(s) 810 and memory 820, among other things. Conventional processors include a minimal amount of hardware and software and rely extensively on external hardware and software. By contrast, an SOC implementation of a processor is more powerful, as it embeds hardware and software therein that enable particular functionality with minimal or no reliance on external hardware and software. For example, the card data visualization system 110 and/or functionality associated therewith can be embedded within hardware in an SOC architecture.

The input device(s) 850 and output device(s) 860 can be communicatively coupled to the computing device 800. By way of example, the input device(s) 850 can include a pointing device (e.g., mouse, trackball, stylus, pen, touchpad), keyboard, joystick, microphone, voice user interface system, camera, motion sensor, and a global positioning satellite (GPS) receiver and transmitter, among other things. The output device(s) 860, by way of example, can correspond to a display device (e.g., liquid crystal display (LCD), light-emitting diode (LED), plasma, organic light-emitting diode display (OLED) . . . ), speakers, voice user interface system, printer, and vibration motor, among other things. The input device(s) 850 and output device(s) 860 can be connected to the computing device 800 by way of wired connection (e.g., bus), wireless connection (e.g., Wi-Fi, Bluetooth), or a combination thereof.

The computing device 800 can also include communication connection(s) 870 to enable communication with at least a second computing device 802 utilizing a network 890. The communication connection(s) 870 can include wired or wireless communication mechanisms to support network communication. The network 890 can correspond to a personal area network (PAN), local area network (LAN), or a wide area network (WAN), such as the internet. In one instance, the computing device 800 can correspond to a first computing device, such as a server, executing the card data visualization system 110. The second computing device 802 can correspond to a user computing device, such as a smartphone, augmented reality glasses, or both. In this instance, the card data visualization system 110 is operating as a service that is accessible by other computing devices. In another instance, the computing device 800 can correspond to a user computing device that executes at least a portion of the card data visualization system 110 locally and makes calls to a server corresponding to the second computing device for additional functionality or data.

What has been described above includes examples of aspects of the claimed subject matter. It is, of course, not possible to describe every conceivable combination of components or methods to describe the claimed subject matter. However, one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems or methods described above may be applied to, or used in accordance with, other systems or methods.

The present techniques will be better understood with reference to the following enumerated embodiments:
A1. A method for secure card data visualization for authentication tokens using augmented reality, the method comprising: receiving, from a user device associated with a user, a request for accessing authentication information for an authentication token, wherein the request comprises a session identifier associated with the user device; retrieving, based on the session identifier, a user profile for the user, wherein the user profile comprises (1) token identifiers for one or more authentication tokens associated with the user and (2) authentication information of each of the one or more authentication tokens; receiving an indication that an NFC interaction has been initiated between the user device and the authentication token, wherein the indication includes a token identifier for the authentication token; determining whether the authentication token is associated with the user; in response to determining that the authentication token is associated with the user, rendering the authentication information into a graphical overlay for display on the user device; and transmitting to the user device the graphical overlay for displaying, on a display of the user device, the authentication information over an image of the authentication token captured via an imaging sensor included in the user device.
A2. The method of any of the preceding embodiments, wherein determining that the authentication token is associated with the user comprises: comparing the token identifier for the authentication token and the token identifiers from the user profile; and determining that the token identifier for the authentication token corresponds to one of the token identifiers from the user profile.
A3. The method of any of the preceding embodiments, further comprising determining, based on the user profile, one or more user actions associated with the authentication token; rendering one or more options for performing the one or more user actions into a second graphical overlay for display on the user device; and transmitting to the user device the second graphical overlay for displaying, on a display of the user device, the one or more options for performing the one or more user actions.
A4. The method of any of the preceding embodiments, further comprising in response to receiving a second indication of a user selection for performing a user action of the one or more user actions; transmitting a command for performing the user action.
A5. The method of any of the preceding embodiments, further comprising receiving a second indication that the user is not within proximity of the user device as determined by a second imaging sensor included in the user device; and transmitting, to the user device, a command to terminate display of the graphical overlay of the authentication information.
A6. The method of any of the preceding embodiments, further comprising determining whether a threshold period of time has been exceeded since transmitting the graphical overlay for display; in response to determining that the threshold period of time has been exceeded, rendering the authentication information into an obfuscated graphical overlay for display on the user device; and transmitting to the user device the obfuscated graphical overlay for displaying, on a display of the user device.
A7. The method of any of the preceding embodiments, further comprising determining whether session data associated with the session identifier is present in a session store; and in response to determining that the session data is not present in the session store, transmitting, to the user device, a command for displaying a request for access information on a display of the user device.
A8. The method of any of the preceding embodiments, further comprising in response to an indication that the NFC interaction has ended, transmitting to the user device a command to terminate display of the graphical overlay of the authentication information.
A9. A tangible, non-transitory, machine-readable medium storing instructions that, when executed by a data processing apparatus, cause the data processing apparatus to perform operations comprising those of any of embodiments A1-A8.
A10. A system comprising: one or more processors; and memory storing instructions that, when executed by the one or more processors, cause the processors to effectuate operations comprising those of any of embodiments A1-A8.
A11. A system comprising means for performing any of embodiments A1-A8.
A12. A system comprising cloud-based circuitry for performing any of embodiments A1-A8.
B1. A system, comprising: a processor coupled to a memory that stores instructions that, when executed by the processor, cause the processor to: detect a presence of a payment authentication token in view; determine data associated with the payment authentication token, including user name, account number, expiration date, and security code; generate a visualization of the data; and transmit the visualization for display by a display device on or near the payment authentication token.
B2. The system of any of the preceding embodiments, wherein the instructions further cause the processor to invoke a computer vision technique to detect the presence of the payment authentication token.
B3. The system of any of the preceding embodiments, wherein the instructions further cause the processor to detect the presence of the payment authentication token based on detection of a radio frequency signal from the payment authentication token.
B4. The system of any of the preceding embodiments, wherein the instructions further cause the processor to: determine a unique identifier associated with the payment authentication token; and look up data associated with the payment authentication token based on the unique identifier.
B5. The system of any of the preceding embodiments, wherein the display device projects the visualization on the payment authentication token.
B6. The system of any of the preceding embodiments, wherein the display device displays the visualization in augmented reality.
B7. The system of any of the preceding embodiments, wherein the instructions further cause the processor to: determine a location associated with the payment authentication token; identify a merchant within a predetermined distance; determine a discount associated with the merchant; generate a discount visualization; and transmit the discount visualization to the display device for display in conjunction with the payment authentication token.
B8. The system of any of the preceding embodiments, wherein the instructions further cause the processor to: determine an upcoming payment due date associated with the payment authentication token; generate a due date visualization; and transmit the due date visualization to the display device for display in conjunction with the payment authentication token.
B9. The system of any of the preceding embodiments, wherein the instructions further cause the processor to: detect a face of a user; present the payment authentication token data; and obscure the payment authentication token data when the face of the user is not detected or an additional face is detected.
B10. The system of any of the preceding embodiments, wherein the instructions further cause the processor to transmit the visualization to the display for presentation in virtual reality.
B11. A method of visualizing data, comprising: executing, on a processor, instructions that cause the processor to perform operations, the operations comprising: detecting a presence of a payment authentication token; determining data associated with the payment authentication token, including user name, account number, expiration date, and security code; generating a visualization of the data; and transmitting the visualization for display by a display device on or near the payment authentication token.
B12. The method of any of the preceding embodiments, wherein the operations further comprise invoking a computer vision technique to detect the presence of the payment authentication token.
B13. The method of any of the preceding embodiments, wherein the operations further comprise detecting the presence of the payment authentication token based on a radio frequency signal from the payment authentication token.
B14. The method of any of the preceding embodiments, wherein the operations further comprise transmitting the visualization to an augmented reality device for display in augmented reality.
B15. The method of any of the preceding embodiments, wherein the operations further comprise transmitting the visualization to the display device for presentation in virtual reality.
B16. The method of any of the preceding embodiments, wherein the operations further comprise: determining a geographic location associated with the payment authentication token; identifying a merchant within a predetermined distance of the geographic location; determining a discount associated with the merchant; generating a discount visualization; and conveying the discount visualization to the display device for display in conjunction with the payment authentication token.
B17. The method of any of the preceding embodiments, wherein the operations further comprise: determining an upcoming payment due date associated with the payment authentication token; generating a due date visualization; and conveying the due date visualization to the display device for display in conjunction with the payment authentication token.
B18. A computer-implemented method, comprising: detecting the presence of a payment authentication token with computer-vision-based object detection; identifying a unique identifier associated with the payment authentication token; looking up data associated with the payment authentication token, including user name, account number, expiration date, and security code based on the unique identifier; generating a visualization of the data; and presenting the visualization in augmented reality on or near the payment authentication token.
B19. The computer-implemented method of any of the preceding embodiments, further comprising determining a geographic location of the payment authentication token; identifying a merchant within a predetermined distance of the geographic location; determining a discount associated with the merchant; generating a discount visualization; and presenting discount visualization in augmented reality on or near the payment authentication token.
B20. The computer-implemented method of any of the preceding embodiments, further comprising determining an upcoming payment due date associated with the payment authentication token; generating a due date visualization; and presenting the due date visualization in augmented reality on or near the payment authentication token.

What is claimed is:

1. A system for secure authentication information retrieval for authentication tokens using augmented reality, the system comprising:
one or more processors; and
a non-transitory, computer-readable medium comprising instructions that, when executed by the one or more processors, cause operations comprising:
receiving, from a user device associated with a user, a request for accessing authentication information for an authentication token, wherein the request comprises a session identifier associated with the user device;
retrieving, based on the session identifier, a user profile for the user, wherein the user profile comprises (1) token identifiers for one or more authentication tokens associated with the user, and (2) authentication information of each of the one or more authentication tokens;
receiving an indication that a near field communication (NFC) interaction has been initiated between the user device and the authentication token, wherein the indication includes a token identifier for the authentication token;
determining, based on comparing the token identifier for the authentication token and the token identifiers from the user profile, whether the authentication token is associated with the user;
in response to determining that the authentication token is associated with the user, rendering the authentication information into a graphical overlay for display on the user device; and
transmitting to the user device the graphical overlay for displaying, on a display of the user device, the authentication information over an image of the authentication token captured via an imaging sensor included in the user device.

2. The system of claim 1, wherein the instructions cause the one or more processors to perform operations comprising:
determining, based on the user profile, one or more user actions associated with the authentication token;
rendering one or more options for performing the one or more user actions into a second graphical overlay for display on the user device; and
transmitting to the user device the second graphical overlay for displaying, on the display of the user device, the one or more options for performing the one or more user actions.

3. The system of claim 1, wherein the instructions cause the one or more processors to perform operations comprising:
receiving a second indication that the user is not within proximity of the user device as determined by a second imaging sensor included in the user device; and
transmitting, to the user device, a command to terminate display of the graphical overlay of the authentication information.

4. The system of claim 1, wherein the instructions cause the one or more processors to perform operations comprising:
determining whether a threshold period of time has been exceeded since transmitting the graphical overlay for display;
in response to determining that the threshold period of time has been exceeded, rendering the authentication information into an obfuscated graphical overlay for display on the user device; and
transmitting to the user device the obfuscated graphical overlay for displaying on the display of the user device.

5. A method for secure authentication information retrieval for authentication tokens using augmented reality, the method comprising:
receiving, from a user device associated with a user, a request for accessing authentication information for an authentication token, wherein the request comprises a session identifier associated with the user device;
retrieving, based on the session identifier, a user profile for the user, wherein the user profile comprises (1) token identifiers for one or more authentication tokens associated with the user, and (2) authentication information of each of the one or more authentication tokens;
receiving an indication that a near field communication (NFC) interaction has been initiated between the user device and the authentication token, wherein the indication includes a token identifier for the authentication token;
determining whether the authentication token is associated with the user; and
in response to determining that the authentication token is associated with the user, rendering the authentication information into a graphical overlay for display on a user device.

6. The method of claim 5, further comprising transmitting to the user device the graphical overlay for displaying, on a display of the user device, the authentication information over an image of the authentication token captured via an imaging sensor included in the user device.

7. The method of claim 5, wherein determining that the authentication token is associated with the user comprises:
comparing the token identifier for the authentication token and the token identifiers from the user profile; and
determining that the token identifier for the authentication token corresponds to one of the token identifiers from the user profile.

8. The method of claim 6, further comprising:
determining, based on the user profile, one or more user actions associated with the authentication token;
rendering one or more options for performing the one or more user actions into a second graphical overlay for display on the user device; and
transmitting to the user device the second graphical overlay for displaying, on a display of the user device, the one or more options for performing the one or more user actions.

9. The method of claim 8, further comprising, in response to receiving a second indication of a user selection for performing a user action of the one or more user actions, transmitting a command for performing the user action.

10. The method of claim 6, further comprising:
receiving a second indication that the user is not within proximity of the user device as determined by a second imaging sensor included in the user device; and
transmitting, to the user device, a command to terminate display of the graphical overlay of the authentication information.

11. The method of claim 6, further comprising:
determining whether a threshold period of time has been exceeded since transmitting the graphical overlay for display;
in response to determining that the threshold period of time has been exceeded, rendering the authentication information into an obfuscated graphical overlay for display on the user device; and
transmitting to the user device the obfuscated graphical overlay for displaying, on a display of the user device.

12. The method of claim 6, further comprising, in response to an indication that the near field communication (NFC) interaction has ended, transmitting to the user device a command to terminate display of the graphical overlay of the authentication information.

13. A non-transitory, computer-readable medium storing instructions that, when executed by one or more processors, cause the one or more processors to perform operations comprising:
receiving, from a user device associated with a user, a request for accessing authentication information for an authentication token, wherein the request comprises a session identifier associated with the user device;
retrieving, based on the session identifier, a user profile for the user, wherein the user profile comprises (1) token identifiers for one or more authentication tokens associated with the user, and (2) authentication information of each of the one or more authentication tokens;
receiving an indication that a near field communication (NFC) interaction has been initiated between the user device and the authentication token, wherein the indication includes a token identifier for the authentication token;
in response to determining that the authentication token is associated with the user, rendering the authentication information into a graphical overlay for display on the user device; and
transmitting to the user device the graphical overlay for displaying, on a display of the user device, the authentication information over an image of the authentication token captured via an imaging sensor included in the user device.

14. The non-transitory, computer-readable medium of claim 13, wherein determining that the authentication token is associated with the user comprises:
comparing the token identifier for the authentication token and the token identifiers from the user profile; and
determining that the token identifier for the authentication token corresponds to one of the token identifiers from the user profile.

15. The non-transitory, computer-readable medium of claim 13, wherein the instructions cause the one or more processors to perform operations comprising:
determining, based on the user profile, one or more user actions associated with the authentication token;
rendering one or more options for performing the one or more user actions into a second graphical overlay for display on the user device; and
transmitting to the user device the second graphical overlay for displaying, on a display of the user device, the one or more options for performing the one or more user actions.

16. The non-transitory, computer-readable medium of claim 15, wherein the instructions cause the one or more processors to perform operations comprising:
in response to receiving a second indication of a user selection for performing a user action of the one or more user actions, transmitting a command for performing the user action.

17. The non-transitory, computer-readable medium of claim 13, wherein the instructions cause the one or more processors to perform operations comprising:
receiving a second indication that the user is not within proximity of the user device as determined by a second imaging sensor included in the user device; and
transmitting, to the user device, a command to terminate display of the graphical overlay of the authentication information.

18. The non-transitory, computer-readable medium of claim 13, wherein the instructions cause the one or more processors to perform operations comprising:
determining whether a threshold period of time has been exceeded since transmitting the graphical overlay for display;
in response to determining that the threshold period of time has been exceeded, rendering the authentication information into an obfuscated graphical overlay for display on the user device; and
transmitting to the user device the obfuscated graphical overlay for displaying on a display of the user device.

19. The non-transitory, computer-readable medium of claim 13, wherein the instructions cause the one or more processors to perform operations comprising:
determining whether session data associated with the session identifier is present in a session store; and
in response to determining that the session data is not present in the session store, transmitting, to the user device, a command for displaying a request for access information on a display of the user device.

20. The non-transitory, computer-readable medium of claim 13, wherein the instructions cause the one or more processors to perform operations comprising:
in response to an indication that the near field communication (NFC) interaction has ended, transmitting to the user device a command to terminate display of the graphical overlay of the authentication information.
